(19) United States
(12) Patent Application Publication
(10) Pub. No.: US 2012/0103965 A1
(43) Pub. Date: May 3, 2012

(54) DIRECT ELECTRICAL HEATING FLOW SYSTEM

(76) Inventor: Sjur Kristian Lund, Halden (NO)

(21) Appl. No.: 13/270,431

(22) Filed: Oct. 11, 2011

(30) Foreign Application Priority Data
Nov. 3, 2010 (NO) 20101543

(51) Int. Cl. H05B 1/00; H05B 3/02

(52) U.S. Cl. 219/388

(57) ABSTRACT

A direct electrical heating flow system (100) includes at least one flow pipe (20) and at least one cable (120) disposed along the at least one flow pipe (20) for heating and/or monitoring the at least one flow pipe (20). The cable (120) includes an inner conductive region (180) surrounded by an annular insulating region (190, 200) and peripheral thereto an outer annular conductive region (210). The inner conductive region (180) encloses an optical fibre waveguide region (160) including at least one optical fibre waveguide (150) for conveying at least one information-bearing signal. Enclosing the optical fibre waveguide region (160) within the inner conductive region (180) and placing a soft bedding (170) under the conductive region (180) renders the cable (120) robust to impact damage as well as being more tolerant to stress elongation.

### RELATED APPLICATION

This application claims the benefit of priority from Norwegian Patent Application No. 2010 1543, filed o Nov. 3, 2010, the entirety of which is incorporated by reference.

### FIELD OF THE INVENTION

The present invention relates to direct electrical heating (DEH) flow systems. Moreover, the invention also concerns methods of manufacturing direct electrical heating (DEH) flow systems.

### BACKGROUND OF THE INVENTION

Many industrial activities require fluids to be transported from one location to another. The fluids can be one or more of: gases, liquids, scum, emulsions. It is conventional contemporary practice to guide such fluids via pipes. In order to avoid the pipes from becoming blocked, for example due to fluids solidifying to block the pipes, it is contemporary practice to provide the pipes with electrical heating therealong. The electrical heating is conveniently provided via cables which are conveyed parallel to pipes providing a route along which fluids can flow. For example, pipes in oil and gas production facilities conveying hydrocarbon gas including water vapour are susceptible to form spontaneously hydrate deposits which can block flow within the pipes. In such situations, direct electrical heating of the pipes is highly beneficial to achieve reliable flow therein.

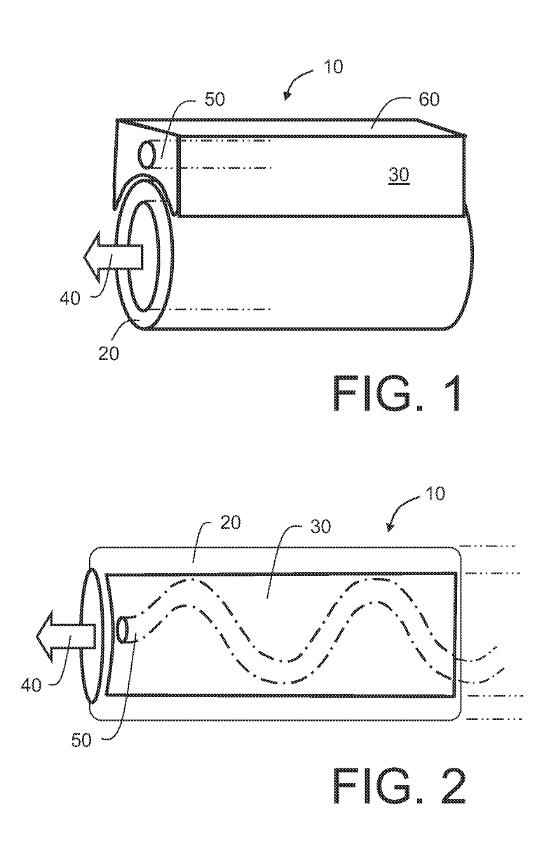

It is contemporary practice in a known type of flow system indicated by 10 in FIG. 1 to include a pipe 20 with a cable conduit 30 mounted in parallel with the pipe 20. The pipe 20 is operable to guide a flow 40 of a fluid therethrough. A cable 50 is included within the conduit 30 for conveying electrical power and signals. A practical problem encountered in practice is that the cable 50 exhibits less thermal expansion in comparison to the pipe 20. Such a difference in thermal expansion can potentially cause at least one of the pipe 20 and the cable 50 to become stressed as temperature of the system 10 varies, and can potentially cause the system 10 to assume a bowed shape. The temperature of the system 10 can vary, for example, on account of the pipe 20 conveying a flow whose temperature temporally varies.

A conventional approach to render the system 10 more robust is to size the conduit 30 so that the cable 50 lies loosely therein, for example in a zigzag snake-like manner as illustrated in FIG. 2. However, such oversizing of the conduit renders the system 10 more bulky in storage, and renders the system 10 more expensive in manufacture as a result of more materials being employed. The system 10 has other problems concerning robustness in that the cables 50 are prone to impact damage. And optical fibres for conveying signals also enclosed within the conduit 30 are prone to sustaining impact damage. A conventional approach to render the system 10 more robust is to provide that conduit 30 with armouring to protect it from impact damage; however, such a solution renders the system 10 expensive and bulky. It is known to provide the aforementioned conduit 30 of the system 10 with compliant impact protection on its outermost surface 60 to provide the cable 50 with an enhanced degree of mechanical protection. However, such an approach merely increases bulk and manufacturing cost of the system 10.

### SUMMARY OF THE INVENTION

The present invention seeks to provide a more robust and economical direct electrical heating flow system.

According to a first aspect of the present invention, there is provided a direct electrical heating flow system as claimed in appended claim 1: there is provided a direct electrical heating flow system including at least one flow pipe and at least one cable disposed along
the at least one flow pipe for heating and/or monitoring the at least one flow pipe, characterized in that
the cable includes an inner conductive region surrounded by an annular insulating region and peripheral thereto an outer annular conductive region; and the inner conducting region encloses an optical fibre waveguide region surrounded by a soft bedding and including at least one optical fibre waveguide for conveying at least one information-bearing signal.

The system according to the invention has soft bedding under the copper wires (the conductive region). When the cable is exposed to impact forces, the copper wires are allowed to decrease the pitch diameter and the layer of copper wires will be able to flex from a circular to oval shape. Due to this, the other material in the cable can absorb the impact energy.

The soft bedding under the copper wires allows the copper wires to decrease the pitch diameter when exposed to an axial load. The copper wires will be stranded with a short lay-length length. The minimum lay angle will typically be 17-20 degrees. A high lay angle will give a short lay length, hence a more flexible (low bending stiffness) power phase. The high lay-angle will enable the copper wires to squeeze harder on the soft bedding when the cable is exposed to an axial load. Hence, the copper wires are able decrease the pitch diameter witch will lead to axial elongation of the copper in the power phase and the tensions in the copper wires are kept below critical limit. When the cable itself can follow the flow lines length variation caused by temperature variation it is not necessary to install the cable with an excess length.

The invention is of advantage in that the cable is more robust, thereby rendering the flow system mo reliable and/or easier to install.

The soft bedding can be a polymer or a rubber sheath.

Optionally, the direct electrical heating flow system is implemented such that the optical fibre waveguide region is centrally disposed within the inner conducting region for providing the optical fibre waveguide region with enhanced protection against impact.

It is an advantage to monitor the temperature of the cable in order to prevent over-heating and failure. In order to monitor the temperature of the cable, the optical fibres can be placed in the centre of the cable. In the centre, the optical fibres are well protected with respect to impact forces, bending and fatigue and will not be the critical element in the cable. Optical fibres can also be used for strain monitoring or traditional signal transmission. The optical fibres can also be used to locate damage on the cable, if the cable is damaged by for example fishing trawls and the insulation system is damaged there will be an increased temperature in the damaged region and hence the damaged region can be located and repaired. If the damage is so severe that the fiber itself is damaged or broken the damaged region can be located and repaired.

Optionally, the direct electrical heating flow system is implemented such that the outer annular conductive region is implemented, at least in part, using electrically-conductive flexible polymer material. More optionally, the electrically-conductive flexible polymer material includes an electrically-conductive rubber material, for example a semiconductive rubber-like material.

Optionally, the direct electrical heating flow system is implemented such that the inner conductive region comprises at least one metallic conductor whose laying angle is in a range of 17°to 20°.

Optionally, the direct electrical heating flow system is implemented such that the annular insulating region is implemented by a semiconductive sheath surrounding the inner conducting region, and a polymer material insulating sheath surrounding the semi-conducting sheath.

Optionally, the thickness of the semiconductive sheath is at least 10-20% of the thickness of the polymer material insulating sheath, and preferably up to 50% of the thickness of the polymer material insulating sheath. Thus, the thickness of the semiconductive sheath can he at least 10% of the thickness of the polymer material insulating sheath, at least 20% of the thickness of the polymer material insulating sheath, in a range of 10 to 20% of the thickness of the polymer material insulating sheath, in a range of 10 to 50% of the thickness of the polymer material insulating sheath, or in a range of 20 to 50% of the thickness of the polymer material insulating sheath.

Optionally, the direct electrical heating flow system is implemented so that the cable is attached via a conduit to the at least one flow pipe. More optionally, the direct electrical heating flow system is implemented such that the conduit is strapped at periodic spatial intervals to the at least one flow pipe. There might be in some cases that additional protection conduits are not needed. The cable will then be directly strapped to the flowline.

Optionally, the direct electrical heating flow system is implemented such that the inner conductive region is adapted to convey current for heating at least a portion of the at least one flow pipe, and the optical fibre waveguide region is operable to convey signals corresponding to one or more physical measurements performed upon the at least one flow pipe.

According to a second aspect of the invention, there is provided a method of manufacturing a cable, characterized in that the method includes:
(a) enclosing an optical fibre waveguide region including at least one optical fibre waveguide within an inner conductive region, wherein the at least one optical fibre waveguide is adapted for conveying at least one information-bearing signal;
(b) enclosing the inner conductive region within an annular insulating region and peripheral thereto an outer annular conductive region.

According to a third aspect of the invention, there is provided a cable adapted for use in a direct electrical heating flow system, characterized in that the cable includes an inner conducting region surrounded by an annular insulating region and peripheral thereto an outer annular conducting region; and the inner conductive region encloses an optical fibre waveguide region including at least one optical fibre waveguide for conveying at least one information-bearing signal.

According to a fourth aspect of the invention, there is provided a method of manufacturing a direct electrical heating flow system pursuant to the first aspect of the invention using a cable pursuant to the third aspect of the invention, characterized in that the method includes:
(a) including the cable within a conduit; and
(b) attaching the conduit to at least one flow tube of the flow system.

Steps (a) and (b) are susceptible to being executed in either order.

### DESCRIPTION OF THE DIAGRAMS

Embodiments of the present invention will now be described, by way of example only, with reference to the following diagrams wherein:

FIG. 1 is an illustration of a contemporary known direct electrical heating (DEH) flow system;

FIG. 2 is an illustration of a zigzag snake-like position of a cable within a conduit of the system in FIG. 1;

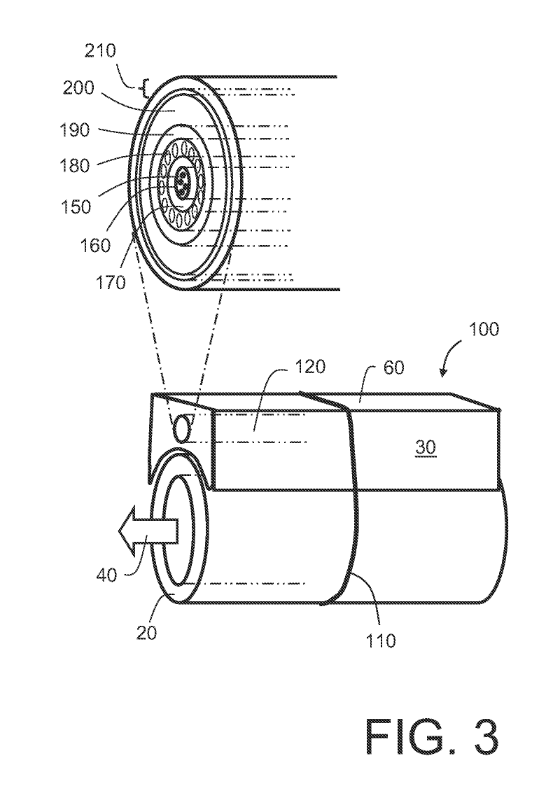

FIG. 3 is an illustration of an embodiment of a direct electrical heating (DEH) flow system according to the present invention; and

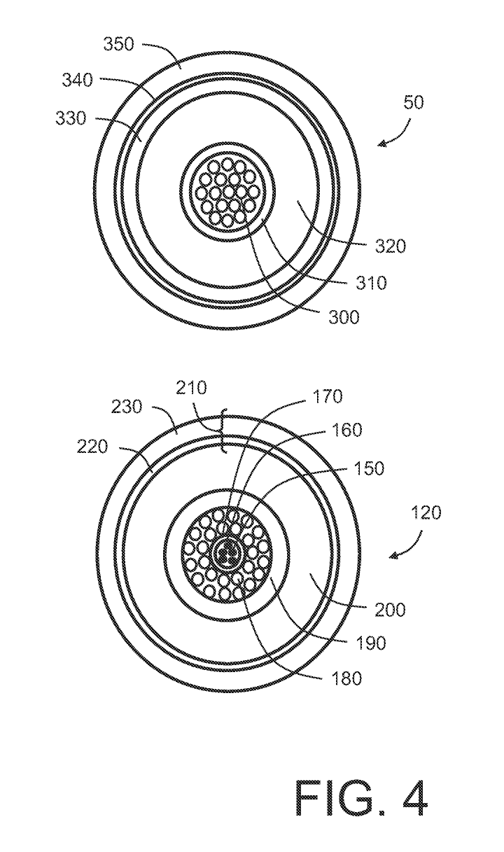

FIG. 4 is an illustration of a cross-section of a cable according to the present invention compared to a cross-section of a conventional cable.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS OF THE INVENTION

The contemporary system 10 of FIG. 1 and FIG. 2 is potentially fragile in that an impact on the conduit 30 can potentially damage the cable 50 and any optical fibres running alongside the cable 50 for conveying control signals and measurement signals. A conventional approach to improve robustness for the system 10 is to improve armouring associated with the conduit 30. However, as aforementioned, such additional armouring increases bulk of the system 10. The present invention seeks to provide an alternative solution to this problem of bulk juxtaposed to robustness.

Referring to FIG. 3, an embodiment of the present invention is a direct electrical heat (DEH) flow system indicated generally by 100. The system 100 is generally similar to the system 10, but with an important difference that the system 100 employs a cable 120 in its conduit 30. Moreover, the system 100 optionally employs straps 110 to bind the conduit 30 to the pipe 20. The cable 120 has a structure which is distinguished from the cable 50. The cable 120 includes a central core having one or more optical fibre waveguides 150 for conveying optical signals, for example as illustrated in a lower portion of FIG. 4. The central core including its waveguides 150 is enclosed within a steel tube sheath 160 which is itself enclosed within a soft sheath 170 of polymer, or rubber. Encircling the soft sheath 170 are one or more annular layers of annealed copper wires 180 which are themselves circumferentially surrounded by a semiconductive sheath 190. The sheath 190 is encircled by a cross-linked polyethylene (PEX) insulating sheath 200. The PEX sheath 200 is surrounded by an outer semiconductive rubber sheath 210 comprising one or more concentric annular layers 220, 230. Although the cable 120 is shown to have a generally circular cross-section, it can optionally be manufactured to have an ellipsoidal cross-section for enabling it to fit more snugly into the conduit 30 of the system 100. Construction of the cable 120 is in itself unique in design, thereby rendering the system 100 unique in design.

Contrary to the cable 120, the conventional cable 50 includes a central core 300 comprising one or more annealed copper wires, a semiconductive sheath 310 surrounding the 300, a PEX insulating sheath 320 surrounding the sheath 310, a semiconductive sheath 330, an annular copper wrapping 340 surrounding the semi-conductive sheath 330, and finally a polyethylene insulating sheath 350 surrounding the copper wrapping 340. The cable 50 therefore has a completely different construction in comparison to the cable 10 used for implementing the present invention. The cable 120 represents a considerable improvement relative to the cable 50 on account several important technical details.

As elucidated in the foregoing, direct electrical heating (DEH) of flow lines is implemented using a high voltage cable attached to the flow lines, for example as illustrated in FIG. 1. Depending upon types of fluid flowing within the flow lines and environmental conditions around the flow lines, the lines are exposed potentially to large temperature differences and will, in consequence due to thermal expansion, exhibit different lengths as a function of temperature variations. Conventionally, high voltage electrical cables exhibit a low elongation capacity of approximately 0.1%; in other words, stretching the electrical cables in their elongate axis by more than approximately 0.1% can result in damage to the cables. However, flow lines are often manufactured from materials, for example high performance polymeric materials or metals, which can exhibit 0.2 to 0.6% length variation over a temperature range over which the flow lines are designed to operate. There therefore arises a need for the high voltage electrical cables running along the flow lines to be able to accommodate changes in length of the flow lines. Moreover, as aforementioned, on account of the flow lines being heavy items, the cables running along the flow lines are prone to suffering impact damage when the flow lines are moved and manoeuvred during installation and/or maintenance. Operationally, it is desirable to monitor temperature along an entire length of the flow lines, or example via use of optical fibre waveguides. In the cable 120 employed in the system 100, the optical fibres 150 are beneficially housed within a steel tube 160 at a centre of the cable 120 for optimal mechanical protection. Optionally, the optical fibres 150 can be employed for purposes of strain monitoring and/or signal communication along the flow lines, namely the pipe 20. Monitoring of temperature along the flow lines is high beneficial, for example, for avoiding freezing which could cause blockage of the flow lines.

The cable 120 employed in the system 100 has considerably better impact survival characteristics in comparison to conventional cables, for example in comparison to the cable 50 employed in the known contemporary system 10. In the cable 50, the polyethylene sheath 350 is expected to bear impact damage so that the copper wrapping 340 amongst others is not damaged, see FIG. 4. In practice, protection offered by the sheath 350 is often inadequate.

The cable 120 can employs soft bedding around its copper wires 180, for example by way of the sheaths 200, 210 which are elastic, compliant a resistant to impact damage. Even the copper wires 180 are able to momentarily deform in the cable 120 to withstand impacts. In the cable 50, the sheath 310 is a weak point; a corresponding layer in the cable 120 is represented by the sheath 190 which can be relatively considerably thicker, for example in a range of 50% to 100% thicker than is customary for the cable 50; beneficially, the sheath 190 is at least 10-20% as thick as the PEX sheath 200, more preferable up to 50% as thick as the PEX sheath 200. Moreover, the cable 120 includes the conductive rubber sheath 210 which provides considerably more robust protection against impact in comparison to the polyethylene sheath 350 of the cable 50. In the cable 120, due to the soft bedding 170, the wires 180 are capable of decreasing their pitch diameter in a situation where the cable 120 is subjected to more severe axial stresses. Optionally, the copper wires 180 are stranded with a short lay-length. Beneficially, the wires 190 have a lay angle in a range of 17° to 20°. By employing such a high lay angle, the cable 120 is rendered less stiff to lateral forces, namely orthogonal to an axial direction of the cable 120, making it more manoeuvrable; such a mechanical characteristic enables the copper wires 180 to be squeezed harder onto their associated soft bedding when the cable 120 is subject to axial stresses, namely axial loads. When the cable 120 is subjected to axial load, the copper wires 180 are capable of decreasing pitch diameter, thereby allowing axial elongation of the cable 120 which also reduces tension in the copper wires 180 to below a critical damage threshold. Thus, the cable 120 is capable of following expansion and contraction of its associated pipe 20, namely flow line, as a consequence of temperature variations without n need for the cable 120 to he laid loosely in a zigzag snake-like manner in the conduit 30.

During operation, it is desirable to measure the temperature of the cable 120, namely for preventing overheating and associated failure. The optical fibre waveguides 150 are adapted to measure a true representative temperature of the cable 120 when the waveguides 150 are disposed centrally within the cable 120. Such a disposition is also synergistically of benefit in that the waveguides 150 are also optimally protected against impact damage, bending and fatigue effects. The optical fibre waveguides 150 are optionally operable to measure strain and temperature by way of Bragg-grating Mach-Zehnder interferometric-type sensors, via thermochromic sensors and similar.

Optionally, the conduit 30 comprises a first portion which is attached to the pipe 20 in FIG. 3, and a second lid portion which cooperates with the first portion to form an elongate cavity for accommodating the cable 120. The conduit 30 is optionally attached to the pipe by way of straps 110, although other forms of attachment may alternatively be employed, for example peripheral helical spiral bands. Although PEX and conductive rubber are mentioned as materials for use in manufacturing the cable 120, it will be appreciated that alternative materials exhibiting generally similar mechanical and electrical properties can alternatively be employed. PEX is manufactured from polyethylene which has been subject to one or more cross-linking process, for example via electron bean exposure, peroxide reaction or similar.

A method of manufacturing the cable 120 will now be described. Initially, the one or more optical fibre waveguides 150 are collected together and then the steel tube 160 formed therearound, for example by folding sides of a steel strip together and then welding together the sides of the strip where they mutually meet together. Thereafter, the polymer sheath 170 is moulded onto the steel tube 160 to which the annealed copper wires are added 180, whilst the semiconductive, sheath 190 is moulded around the wires 180. Thereafter, the layer of PEX polymer 200 is moulded onto the sheath 190 and then finally the semiconductive rubber sheath 210 is added. Manufacture of the cable 120 is beneficially implemented in a roll-good and/moulded continuous manner, thereby enabling the cable 120 to he relatively long, for example several kilometres long. It will be appreciated in a length of the cable 120 several kilometres in length and required to exhibit high integrity of insulation along its length, namely be uncompromised in performance, that damage at one or more specific locations along the cable 120 can represent enormous economic loss. In such a context, the present invention is potentially of enormous value by rendering the cable 120 highly robust.

1. A direct electrical heating flow system comprising:
at least one flow pipe; and
at least one cable disposed along said at least one flow pipe for heating and/or monitoring said at least one flow pipe, wherein the cable includes an inner conductive region surrounded by an annular insulating region and peripheral thereto an outer annular conductive region; and
said inner conductive region encloses an optical fibre waveguide region surrounded by a soft bedding and including at least one optical fibre waveguide for conveying at least one information-bearing signal.

2. A direct electrical heating flow system as claimed in claim 1, wherein the soft bedding is a polymer or a rubber sheath.

3. A direct electrical heating flow system as claimed in claim 1, wherein the optical fibre waveguide region is centrally disposed within said inner conductive region.

4. A direct electrical heating flow system as claimed in claim 1, wherein said outer annular conductive region is implemented, at least in part, using electrically-conductive flexible polymer material.

5. A direct electrical heating flow system as claimed in claim 4, wherein said electrically-conductive flexible polymer material includes an electrically-conducting rubber material.

6. A direct electrical heating flow system as claimed in claim 1, wherein said inner conductive region further comprises at least one metallic conductor whose laying angle is in a range of 17° to 20°.

7. A direct electrical heating flow system as claimed in claim 1, wherein the annular insulating region is implemented by a semiconductive sheath surrounding the inner conductive region, and a polymer material insulating sheath surrounding the semiconductive sheath.

8. A direct electrical heating flow system as claimed in claim 7, wherein the thickness of the semiconductive sheath is at least 10% of the thickness of the polymer material insulating sheath.

9. A direct electrical heating flow system as claimed in claim 1, wherein said optical fibre waveguide region is protected within a metallic tube.

10. A direct electrical heating flow system as claimed in claim 1, wherein the cable is attached via a conduit to the at least one flow pipe.

11. A direct electrical heating flow system as claimed in claim 10, wherein the conduit is strapped at periodic spatial intervals to the at least one flow pipe.

12. A direct electrical heating flow system as claimed in claim 1, wherein said inner conductive region is adapted to convey current for heating at least a portion of said at least one flow pipe, and said optical fibre waveguide region is operable to convey signals corresponding to one or more physical measurements performed upon said at least one flow pipe.
